(19) United States
(12) Patent Application Publication
(10) Pub. No.: US 2015/0371301 A1
(43) Pub. Date: Dec. 24, 2015

(54) SYSTEM AND METHODS IN A COMMUNICATION NETWORK FOR USE IN RETAIL APPLICATIONS

(71) Applicant: KONINKLIJKE PHILIPS N.V., Eindhoven (NL)

(72) Inventors: DZMITRY VIKTOROVICH ALIAKSEYEU, EINDHOVEN (NL); JONATHAN DAVID MASON, EINDHOVEN (NL)

(21) Appl. No.: 14/763,081

(22) PCT Filed: Jan. 22, 2014
(86) PCT No.: PCT/IB2014/058454

§ 371 Date: Jul. 23, 2015

Related U.S. Application Data
(60) Provisional application No. 61/757,751, filed on Jan. 29, 2013.

(30) Foreign Application Priority Data
Jul. 22, 2013 (EP) 13177419.2

(51) Int. Cl. G06Q 30/06

(52) U.S. Cl. CPC G06Q 30/0611

(57) ABSTRACT

A system (100) is disclosed, including a user device (110) and a store identification entity (130) connected to a communication network (140). The user device (110) comprises an item information acquirer (112) and can send item information to the store identification entity (130) which is arranged to determine whether at least one store (120) is offering for sale a selected item (150) that is also for sale in a selected venue (160). The item information includes an item identification identifying the item (150), and possibly a venue identification identifying the venue (160). The store identification entity (130) is arranged to, based on the item identification included in the item information, receive information from one or more stores (120) regarding whether the respective stores (120) are offering the item (150) for sale. The store identification entity (130) is arranged to, on a condition that at least one store (120) is offering the item for sale, transmit an indication to the at least one store (120), wherein the indication includes the item identification and the venue identification. Hence, according to embodiments of the present invention the store identification entity (130) transmits both the item identification and the venue identification to at least one store (120) which sells the item (150), which venue identification identifies the venue (160) in which the item (150) is located. Transmitting both the item identification and the venue identification to the at least one store (120) which sells the item (150) identified by the item identification may for example facilitate or enable the venue (160) to claim part benefit from any transaction occurring between a store (120) and the user device (110), even if the user device (110) or customer, e.g. the user of the user device (110), does not subsequently purchase the item (150) from the venue (160). A user device (110) and a store identification entity (130) included in the system (100) are also disclosed.

### FIELD OF THE INVENTION

The present invention generally relates to applications in communication networks. Specifically, the present invention relates to systems and methods implemented at least in part in a communication network which may be useful in retail applications.

### BACKGROUND OF THE INVENTION

Retailers or shop keepers employ local stores for selling items or products to customers. By local stores it is meant ‘physical’ stores where customers can enter the store, examine an item or product for sale in the store, and buy the product or item from the store.

However, with the advent so called smartphones and a variety of applications therefor, which smartphones generally have access to communication networks including the Internet, a new type of services, or mobile applications, for online shopping have recently emerged that enables a user or customer to retrieve information relating to a product or item for sale at a location using a user device such as a mobile telephone and particularly a smartphone, and then use that information to find online shops that offer that product or item for sale. Retrieving the information relating to the product or item for sale at the location can for example be effected by means of scanning a barcode, e.g. an Universal Product Code (UPC), on the product or item, or by means of capturing an image or picture of the product or item and subsequent appropriate image processing of the captured image, using the user device.

Since retailers employing online shops only in general are able to set a more competitive price level on products compared to retailers with local stores, as they may not have the overhead and/or costs associated with running a ‘physical’ store, the user may identify online shops that offer that particular product or item for less money compared to the local store in which the customer retrieved the information relating to the product or item. The customer may further perceive that purchasing the product or item from the online shop is more convenient than purchasing it from the local store. In any case, the customer can subsequently purchase the product or item from one of the identified online shops. Examples of mobile applications with such functionality or related functionality are offered by ShopSavvy and Amazon. Using such mobile application, possibly with part add-on application, the customer can instantly purchase the product or item online from one of the identified online shops, perhaps even without leaving the ‘physical’ or local store in which the customer retrieved the information relating to the product or item. Hence, the retailer with the ‘physical’ or local store may run the risk of losing custom if its prices are not as competitive as the online shop's prices.

Such mobile applications may affect how local stores will operate in the future. For example, keepers or owners of local stores may try to prevent use of such mobile applications in their stores, e.g. by removing visible barcode or other product identifiers which can be used in the above-mentioned mobile application, and other means for product identification, e.g. radio frequency identification (RFID). The average customer may know that retailers with only online shops may be able to set a more competitive price level on products compared to retailers with local stores. In view of this it would be desirable to attain a balance between the desire of customers to enjoy ‘physical’ shopping experiences, i.e. shopping in ‘physical’ or local shops, and the desire to find products at lower price levels online. A scenario where both an online shop and a local shop can benefit when the customer purchases a product or item from the online shop using information relating to that product or item, obtained using a mobile application such as described in the foregoing in the local shop, would be desirable.

### SUMMARY OF THE INVENTION

In view of the above discussion, a concern of the present invention is to provide or achieve a way of facilitating or even enabling a balance to be made between the desire of customers to enjoy ‘physical’ shopping experiences, i.e. shopping in ‘physical’ or local shops, and the desire to find products at lower price levels online.

A further concern of the present invention is to provide or achieve a way of facilitating or even enabling both an online shop and a local shop to benefit when a customer purchases a product or item from an online shop using information relating to that product or item obtained using a mobile application such as described in the foregoing section in the local shop.

Yet another concern of the present invention is to provide or achieve a way of facilitating or even enabling a local store or venue to claim part benefit from any transaction occurring between a store or online shop and a user device as a result of the user device determining item information of the item in or from the vicinity of the venue, even though the user device or customer, e.g. the user of the user device, does not purchase the item from the venue.

To address at least one of these concerns and other concerns, a system, a user device, a store identification entity, methods and computer program products in accordance with the independent claims are provided. Preferred embodiments are defined by the dependent claims.

According to a first aspect of the present invention, there is provided a system including a user device and a store identification entity connected to a communication network. The store identification entity is arranged to determine whether at least one store is offering for sale an item that is also for sale in a venue. The user device includes an item information acquirer arranged to acquire item information relating to a selected item, wherein the item information includes an item identification identifying the item and a venue identification identifying the venue. The user device is arranged to transmit the item information to the store identification entity via the communication network. The store identification entity is arranged to, based on the item identification included in the item information, receive information from at least one store via the communication network regarding whether the store is offering the item for sale, and, on a condition that at least one store is offering the item for sale, transmit an indication to the at least one store via the communication network, wherein the indication includes the item identification and the venue identification.

Hence, according to embodiments of the present invention the store identification entity transmits to the at least one store which sells the item identified by the item identification both the item identification and the venue identification, which venue identification identifies the venue in which the item identified by the item identification is located, which item may have been used by the user device to determine the item information. Transmitting both the item identification and the venue identification to at least one store which sells the item identified by the item identification may for example facilitate or even enable the venue to claim part benefit from any transaction occurring between a store which may be an online shop and the user device as a result of the user device determining item information of the item within the venue or in the vicinity of the venue or in another location where the venue has placed said item, even if the user device or customer, e.g. the user of the user device, does not subsequently purchase the item from that venue.

In the context of the present application, by the user device or customer not purchasing the item from the venue it is meant that the user device or customer does not purchase the item ‘physically’ in and/or from the venue, e.g. not from a salesman or saleswoman in the venue.

In the context of the present application, by the term “venue” it is meant a ‘physical’ or local store or shop, e.g. a location where customers can enter, browse the available items or products for sale and buy one or more products or items, such as is possible e.g. in a supermarket.

In the context of the present application, the term “user device” encompasses devices such as wireless transmit/receive units, mobile telephones and/or smartphones, etc.

In the context of the present application, the term “store” encompasses but is not limited to online shops, i.e. shops accessible by a customer using the Internet and from which items or products can be purchased by means of a transaction or transactions carried out e.g. via or over the Internet. The store identification entity can have a relationship with one or more stores, for example, the store identification entity can access the product catalogue of the one or more stores, initiate transactions in the one or more stores or provide data related to the one or more stores to the user device to allow a user to have access to the one or more stores.

The item information acquirer may for example include an optical sensor arranged to receive optical radiation reflected by at least a portion of the selected item in the venue, and determine item information relating to the item based on the received optical radiation, wherein the item information includes an item identification identifying the item and a venue identification identifying the venue. In alternative or in addition, the item information acquirer may include radio frequency identification (RFID) means for acquiring or determining item information relating to the item utilizing RFID technology such as known to a person skilled in the art. For example, the item information acquirer may include a wireless transceiver arranged to receive item information relating to the item from or via an RFID tag or unit arranged on or in the item, which RFID tag or unit may include a memory on which there is stored the item information and a wireless transceiver. In alternative or in addition, the item information acquirer may include a user interface arranged to receive user input that determines the item information, e.g. by allowing a user of the user device to enter or type in for example a name of the item or product, a model number of the item, an Universal Product Code (UPC) of the item and/or an identification of the venue in which the item is for sale. In alternative or in addition, the item information acquirer may include any other suitable means for acquiring or determining the item information relating to the item.

It is to be understood that any of the examples of the item information acquirers described in the foregoing or other suitable examples of item information acquirers may be used in any one of the aspects of the present invention described herein.

In the context of the present application, the term “optical radiation” generally encompasses pulses or continuous waves of electromagnetic radiation of any wavelength or within any wavelength range suitable for the particular application, for example microwave radiation, infrared radiation and/or visible light.

The store identification entity may for example include or be part of a system or entity implementing a so called smart store system, or the smart store system itself. The store identification entity may be arranged to identify stores such as online stores or shops, determine whether a particular item or product is offered for sale by those stores, and/or facilitate or even enable the user device, or the user of the user device, to effect purchasing of that particular item or product from any store offering the item or product for sale.

In the context of the present application, by the term “communication network” it is meant a wireless communication network, a wired communication network, or a communication network where a portion of the communication network is wired and a portion of the communication network is wireless, with the appropriate interfaces between the wired and wireless portions of the communication network as known to a person skilled in the art.

The communication network may for example include the Internet, a wireless local area network (WLAN) employing part wireless distribution method, e.g. spread-spectrum or orthogonal frequency multiplexing, a metropolitan area network, and/or a wide area network, such as known to the person skilled in the art. The WLAN may for example be based on IEEE 802.11 standards. A user device connected to the communication network and a store identification entity connected to the connection network does not imply that both are directly connected to the same communication network; for example the user device might connect to a mobile phone operator's network and the store identification entity might connect to a hosting service provider's network. Each of these networks can then, directly or indirectly, be connected to each other (e.g. when the mobile phone operator's network and the hosting service provider's network both have an Internet connection).

The optical sensor may for example capture and extract data from coded light, such as the venue identification; include a barcode scanner or barcode reader arranged to read a barcode of an item, with the barcode typically being arranged on an outer surface of the item; include an imaging device arranged to capture at least one image of an item, which captured image or images can be processed so as to determine item information relating to the item; or include any other device capable of determining information pertaining to an item by receiving optical radiation reflected by at least a portion of the item, which received optical radiation may have originated in the device itself, and determine item information relating to the item based on the received optical radiation, or any combination thereof.

The user device or the optical sensor may include an image processing unit arranged to process at least one image captured by the imaging device, possibly by means of processing an image representation of the captured at least one image, which image representation may have been produced by the image processing unit or by part image conversion unit that may be arranged in the optical sensor or in the user device separate from the optical sensor.

The store identification entity may be arranged to transmit the item identification included in the item information to at least one store, by means of which in response one or more stores transmit information via the communication network to the store identification entity whether the respective store(s) are offering the item associated with the item identification for sale.

The indication may include at least an intention of the user of the user device of purchasing the item from the at least one store offering the item for sale.

The at least one store may be arranged to, on a condition that the item is purchased, e.g. by a user of the user device, from the at least one store, transmit a message to the venue identified by the venue identification and/or the store identification entity indicating that the item associated with the item identification was sold by the at least one store.

The message may for example include an indication of a fraction of a cost of the item associated with the item identification which was sold by the at least one store, to which fraction the venue identified by the venue identification and/or the store identification entity or the keeper of the venue identified by the venue identification respectively the keeper (e.g. owner, provider) of the store identification entity is entitled to. In the context of the present application, the term “cost” generally encompasses cost price, purchase price, discount price or any other financial figure, such as an inventive, commission, etc. related to an item, such as a product, for sale.

Principles or features of embodiments of the present invention may hence for example provide for referral agreement between ‘physical’ or local shops and online shops, for example so that a percentage of the payment that the customer makes for the item identified by the item identification is transmitted from the online shop, or store, that sold the item to the ‘physical’ shop, or venue, identified by the venue identification. Such principles may be substantially the same or similar to the way so called online referral programs operate or function.

The store identification entity may include a memory unit in which data associated with at least one item which is for sale in the venue identified by the venue identification is stored. The data may relate to at least one product associated with the respective one of the item or items.

The user device may include a user interface arranged to indicate selected data to a user of the user device upon receipt of instruction from the store identification entity via the communication network.

The store identification entity may be arranged to, on a condition that data associated with the item identified by the item identification is stored in the memory unit, retrieve at least part of the data associated with the item identified by the item identification from the memory unit, and transmit the at least part of the data associated with the item identified by the item identification to the user device, and possibly transmit an instruction to the user interface to indicate the transmitted data to the user by means of the user interface. The instruction may be transmitted to the user device together with the at least part of the data.

The data relating to at least one product associated with the respective one of the item or items may for example relate to offers that the venue identified by the venue identification are able to provide the user of the user device, e.g. a potential customer in the venue, which offers pertain to, or are associated with, the item identified by the item identification. The offers may for example include an offer of extended warranty for the item identified by the item identification.

The at least one product associated with the respective one of the item or items to which the data may relate may hence for example include extended warranty. The at least one product associated with the respective one of the item or items to which the data may relate is however not limited to include extended warranty, but may for example in alternative or in addition include an offer of discount on an item or items related to the item identified by the item identification, e.g. accessories or add-ons. Hence, in the context of the present application, the term “product” is not limited to a ‘physical’ item but encompasses also e.g. offers pertaining to a particular item.

The store identification entity may be arranged to, on a condition that data associated with the item identified by the item identification is stored in the memory unit, retrieve at least part of the data associated with the item identified by the item identification from the memory unit, and transmit the at least part of the data associated with the item identified by the item identification to the user device, and possibly transmit an instruction to the user interface to indicate the transmitted data to the user by means of the user interface, responsive to the user device having transmitted the item information to the store identification entity via the communication network. When the user device transmits the item information to the store identification entity via the communication network, the store identification entity becomes aware of that the item information has been obtained by the item information acquirer, for example that the item information has been obtained by the optical sensor of the user device, e.g. that a barcode on the item identified by the item identification has been scanned or that an image of the item identified by the item identification has been captured. The instruction may be transmitted to the user device together with the at least part of the data.

Alternatively or in addition, the store identification entity may be arranged to, on a condition that data associated with the item identified by the item identification is stored in the memory unit, retrieve at least part of the data associated with the item identified by the item identification from the memory unit, and transmit the at least part of the data associated with the item identified by the item identification to the user device, and possibly transmit an instruction to the user interface to indicate the transmitted data to the user by means of the user interface, on a condition that the item identified by the identification has been or is to be purchased from the at least one store. The instruction may be transmitted to the user device together with the at least part of the data.

As another example, the user device may be arranged to query user input when the user interface indicates the at least part of the data associated with the item identified by the item identification to a user of the user device. The user device can then transmit a message based on this user input to the store identification entity. Such is very useful when a specific offer is made to a user of the user device, that the user can then for example accept, acquire additional information on, etc.

For example, the store identification entity may be arranged to retrieve at least part of the data associated with the item identified by the item identification from the memory unit and transmit the at least part of the data associated with the item identified by the item identification to the user device, and possibly transmit an instruction to the user interface to indicate the transmitted data to the user by means of the user interface, further on a condition that the store identification entity has received a message indicating that the item associated with the item identification was sold by at least one store.

The message indicating that the item associated with the item identification was sold by at least one store may be transmitted to the store identification entity via the communication network from the venue or from the at least one store that sold the item associated with the item identification.

According to a second aspect of the present invention, there is provided a user device arranged to be included in a system according to the present invention.

According to a third aspect of the present invention, there is provided a store identification entity arranged to be included in a system according to the present invention.

According to a fourth aspect of the present invention, there is provided a method in a user device comprising an item information acquirer included in a system further including a store identification entity, wherein the user device and the store identification entity are connected to a communication network. The method is for facilitating determination by the store identification entity whether at least one store is offering for sale an item that is also for sale in a venue. The user device includes an item information acquirer arranged to acquire item information relating to an item. The method comprises the item information acquirer acquiring item information relating to a selected item that is put on display by a venue, wherein the item information includes an item identification identifying the item and a venue identification identifying the venue; and the user device transmitting the item information to the store identification entity; store identification entity, based on the item identification included in the item information, determining whether a least one store is offering the item for sale, and, on a condition that at least one store is offering the item for sale, transmitting an indication to the at least one store via the communication network, wherein the indication includes the item identification and the venue identification.

According to a fifth aspect of the present invention, there is provided a method in a store identification entity included in a system further including a user device, wherein the user device and the store identification entity are connected to a communication network. The method is for determining whether at least one store is offering for sale an item that is also for sale in a venue. The user device includes an item information acquirer arranged to acquire item information relating to an item, wherein the item information includes an item identification identifying the item and a venue identification identifying the venue. The method comprises the store identification entity receiving the item information related to a selected item from the user device; based on the item identification included in the item information, receiving information from at least one store regarding whether the at least one store is offering the item for sale; and on a condition that at least one store is offering the item for sale, transmitting an indication to the at least one store via the communication network, wherein the indication includes the item identification and the venue identification.

According to a sixth aspect of the present invention, there is provided a computer program product arranged to be executed in a processing unit of a user device included in a system further including a store identification entity, wherein the user device and the store identification entity are connected to a communication network. The computer program product comprises computer-readable means carrying computer program code configured to, when executed in the processing unit, perform a method according to the fourth aspect of the present invention.

According to a seventh aspect of the present invention, there is provided a computer program product arranged to be executed in a processing unit of a store identification entity included in a system further including a user device, wherein the user device and the store identification are connected to a communication network. The computer program product comprises computer-readable means carrying computer program code configured to, when executed in the processing unit, perform a method according to the sixth aspect of the present invention.

The processing unit of the user device and/or the store identification entity may for example include or be constituted by any suitable central processing unit (CPU) or the like. The processing unit may optionally be capable of executing software instructions stored in a computer program product e.g. in the form of a memory. The memory may for example be any combination of read and write memory (RAM) and read only memory (ROM).

Further objects and advantages of the present invention are described in the following by means of exemplifying embodiments.

It is noted that the present invention relates to all possible combinations of features recited in the claims. Further features of, and advantages with, the present invention will become apparent when studying the appended claims and the following description. Those skilled in the art realize that different features of the present invention can be combined to create embodiments other than those described in the following.

### BRIEF DESCRIPTION OF THE DRAWINGS

Exemplifying embodiments of the invention will be described below with reference to the other accompanying drawings, in which:

FIG. 1 is a schematic block diagram of a system according to an embodiment of the present invention;

FIG. 2 is a schematic view of a computer-readable means, or computer-readable storage medium, according to an embodiment of the present invention; and

FIGS. 3 and 4 are schematic flowcharts of methods according to embodiments of the present invention.

In the accompanying drawings, the same reference numerals denote the same or similar elements throughout the views.

### DETAILED DESCRIPTION

The present invention will now be described more fully hereinafter with reference to the accompanying drawings, in which exemplifying embodiments of the present invention are shown. The present invention may, however, be embodied in many different forms and should not be construed as limited to the embodiments set forth herein; rather, these embodiments are provided by way of example so that this disclosure will convey the scope of the invention to those skilled in the art. Furthermore, like numbers refer to the same or similar elements or components throughout. The steps of any method described herein do not have to be performed in the exact order as described, unless specifically stated.

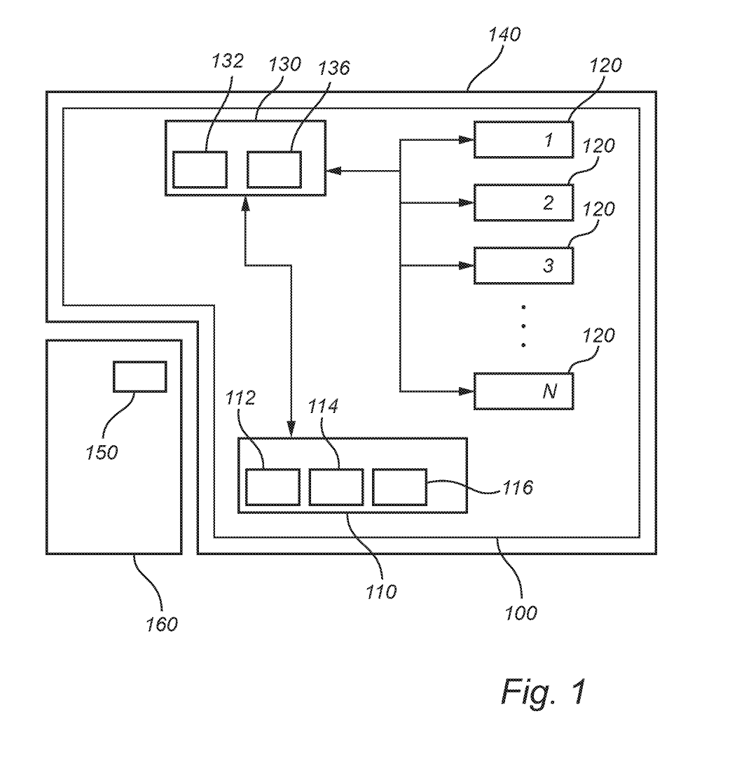

Referring now to FIG. 1, there is shown a schematic block diagram of a system 100 according to an embodiment of the present invention. The system 100 comprises a user device 110, a plurality of stores 120 and a store identification entity 130. The user device 110, the plurality of stores 120 and the store identification entity 130 are included in a communication network 140. According to the embodiment depicted in FIG. 1, there are N stores 120, numbered from 1 to N, where N is a positive integer.

The user device 110 may for example include or be constituted by a so called smartphone, e.g. a mobile phone built on a mobile operating system having functionality including one or several of a portable media player, an imaging device such as a digital camera, Global Positioning System (GPS) navigation unit (e.g. for determining venue information based on GPS coordinates), etc., combined with the functionality of a mobile phone. Smartphones may include a user interface e.g. including a touch-sensitive screen or the like, capable of displaying e.g. web browsers that can display standard web pages as well as web pages optimized for viewing by a mobile device, and be capable of transmitting and receiving signals, data, etc., e.g. by means of Wi-Fi. The mobile operating systems used by a smartphone may include Android from Google, iOS from Apple, Symbian from Nokia, BlackBerry OS from RIM (“Research in Motion”), etc. However, the user device 110 is not limited to a smartphone. For example, the user device 110 may in alternative or in addition include any suitable type of wireless transmit/receive unit or mobile telephone.

Any one of the plurality of stores 120 may for example include a so called online shop, e.g. a shop accessible by a customer by means of the Internet, from which shop items or products can be purchased by means of a transaction or transactions carried out e.g. via the Internet.

The store identification entity 130 may for example include, or be included in, a so called smart store system or entity.

According to the embodiment depicted in FIG. 1 the system 100 is included within the communication network 140. However, this is according to an example and is not to be interpreted in a limiting manner. Rather, the system 100 may in general be included at least in part in the communication network 140.

The store identification entity 130 is arranged to determine whether at least one store 120 of the plurality of stores 120 is offering for sale a selected item 150 that is also for sale in a selected venue 160 or put on display by the selected venue 160. The venue 160 may for example include a ‘physical’ or local store or shop, in which customers can enter, browse and examine the available items for sale and buy one or more items; or the selected item 150 may have been put on display at a location other than the location where the venue 160 is located (e.g. a product is put on display at a local restaurant, in a hotel room, in a display case at an airport). The venue 160 may be included in the communication network 140 (this case is not shown in FIG. 1). The user device 110 may be situated or arranged in the venue 160.

The user device 110 includes an item information acquirer 112 arranged to acquire or determine item information relating to the item 150, wherein the item information includes an item identification identifying the item 150, and a venue identification identifying the venue 160. According to the embodiment depicted in FIG. 1, the item information acquirer 112 includes an optical sensor 112. The optical sensor 112 is arranged to receive optical radiation reflected by at least a portion of the selected item 150 in the venue 160, and determine item information relating to the item 150 based on the received optical radiation. The item information includes an item identification identifying the item 150, and a venue identification identifying the venue 160.

The optical sensor 112 may for example include a barcode scanner or barcode reader arranged to read a barcode, if any, of the item 150. In alternative or in addition, the optical sensor 112 may include an imaging device arranged to capture at least one image of the item 150, which captured image or images subsequently can be processed so as to determine the item information relating to the item 150, and/or any other suitable device capable of determining information pertaining to the item 150 by receiving optical radiation reflected by at least a portion of the item 150, which received optical radiation may have originated in the device itself, and determine item information relating to the item 150 based on the received optical radiation.

In the case where the optical sensor 112 includes an imaging device such as described in the foregoing, the user device 110 may include an image processing unit (not shown in FIG. 1) arranged to process at least one image captured by the imaging device, possibly by means of processing an image representation of the captured at least one image, which image representation may have been produced by the image processing unit or by part image conversion unit that may be arranged in the optical sensor 112 or in the user device 110 separate from the optical sensor 112. The image processing unit may possibly be included in the optical sensor 112.

As indicated in FIG. 1, the user device 110 may acquire or determine the item information relating to the item 150 while situated not within the venue 160. For example, the item 150 may be situated behind a display window or store window (not shown in FIG. 1) of the venue, or store, 160, and the user device 110 may capture an image of the item 150 through the display window. In alternative or in addition, the user device 110 may determine the item information relating to the item 150 while both the user device 110 and the item 150 are situated within the venue 160 (this case is not illustrated in FIG. 1).

It is to be understood that the optical sensor 112 is merely an example of an item information acquirer 112. For example, the item information acquirer 112 may in alternative or in addition capture radio frequency identification (RFID) data (e.g. based on reading an RFID tag) for acquiring or determining item information relating to the item 150 utilizing RFID technology such as known to a person skilled in the art. According to another example, the item information acquirer 112 may in alternative or in addition include a user interface 114 arranged to receive user input that determines the item information, e.g. by allowing a user of the user device 110 to enter or type in for example a name of the item 150, a model number of the item 150, an Universal Product Code (UPC) of the item 150 and/or the venue identification.

The user device 110 is arranged to transmit item information relating to the item 150, for example as determined by the optical sensor 112, to the store identification entity 130 via the communication network 140. As mentioned above, the item information includes an item identification identifying the item 150 and a venue identification identifying the venue 160 which is offering the item 150 for sale.

The store identification entity 130 is arranged to, based on the item identification included in the item information, receive information from at least part of the plurality of stores 120 via the communication network 140 regarding whether the respective stores 120 are offering the item 150 for sale. For example, the store identification entity 130 may be arranged to transmit the item identification included in the item information relating to the item 150 to at least part of the plurality of stores 120, by means of which in response the at least part of the plurality of stores 120 transmit information via the communication network 140 to the store identification entity 130 whether the respective stores 120 are offering the item 150 associated with the item identification for sale.

The store identification entity 130 is arranged to, on a condition that at least one store 120 is offering the item 150 for sale, transmit an indication to the at least one store 120 via the communication network 140, the indication including the item identification and the venue identification included in the item information. The indication may include at least an intention or commitment of the user of the user device 110 to purchase the item 150 from the at least one store 120 that is offering the item 150 for sale.

Although FIG. 1 indicates the case where the communication between the user device 110 and the store identification entity 130 and between the store identification entity 130 and at least part of the plurality of stores 120 is effected via wired communication paths, this is according to an example and is not to be construed as limiting. Rather, communication between the elements in the system 100, e.g. between the user device 110 and the store identification entity 130 and between the store identification entity 130 and at least part of the plurality of stores 120 may be effected via wired communication paths, wireless communication paths, or a combination of wired and wireless communication paths. Hence, the communication network 140 may be a wireless communication network, a wired communication network, or a communication network where a portion of the communication network is wired and a portion of the communication network is wireless, with the appropriate interfaces between the wired and wireless portions of the communication network as known to a person skilled in the art. The communication network 140 may for example include the Internet, a wireless local area network (WLAN) employing part wireless distribution method, e.g. spread-spectrum or orthogonal frequency multiplexing, a metropolitan area network, and/or a wide area network, such as known to the person skilled in the art. The WLAN may for example be based on IEEE 802.11 standards.

Although FIG. 1 indicates the case where communication between the store identification entity 130 and each store 120 of the plurality of stores 120 take place, this is not to be interpreted in a limiting manner. In general, communication between the store identification entity 130 and at least part of the plurality of stores 120 take place.

With further reference to FIG. 1, on a condition that the item 150 is purchased, e.g. by a user of the user device 110, from the at least one store 120 that is offering the item 150 for sale, that or those stores 120 may be arranged to transmit a message to the venue 160 which is identified by the venue identification, which message indicates that the item 150 associated with the item identification was sold by that or those stores 120. The message may for example include an indication of a fraction of a cost of the item 150 associated with the item identification which was sold by a store 120 to which the keeper of the venue 160 identified by the venue identification is entitled to. For example, a percentage of the payment that the customer makes for the item 150 identified by the item identification may be transmitted from the store 120, e.g. an online store, that sold the item 150 to the venue 160, e.g. a ‘physical’ store, identified by the venue identification.

With further reference to FIG. 1, the store identification entity 130 may include a memory unit 132.

The memory unit 132 may be configured to store data associated with at least one item which is for sale in the venue 160 identified by the venue identification. The data stored in the memory unit 132 may for example relate to at least one product associated with the respective ones of one or more of the items which are for sale in the venue 160.

The at least one product may include a ‘physical’ item and/or an offer pertaining to the respective item. The at least one product may for example include extended warranty for the respective item, but is not limited thereto and can for example in alternative or in addition include an offer of discount on another item or other items related to the respective item, e.g. the item 150 identified by the item identification, such as accessories or add-ons.

The user device 110 may include a user interface 114.

The user interface 114 may be arranged to indicate selected data to a user (not shown in FIG. 1) of the user device 110 upon receipt of instruction from the store identification entity 130 via the communication network 140.

The store identification entity 130 may be arranged to, on a condition that data associated with the item 150 identified by the item identification is stored in the memory unit 132, retrieve at least part of the data associated with the item 150 identified by the item identification from the memory unit 132 and transmit the retrieved data to the user device 110. The store identification entity 130 may be arranged to transmit an instruction to the user interface 114 of the user device 110 to indicate the transmitted data to the user by means of the user interface 114. The instruction may be transmitted to the user device 110 together with the retrieved data.

Data which may be stored in the memory unit 132 relating to at least one product associated with the respective ones of one or more of the items which are for sale in the venue 160 may for example relate to offers that the venue 160 identified by the venue identification are able to provide the user of the user device 110, e.g. a potential customer in the venue 160, which offers pertain to or are associated with the item 150 identified by the item identification. The offers may for example include an offer of extended warranty for the item 150 identified by the item identification.

The store identification entity 130 may be arranged to, on a condition that data associated with the item 150 identified by the item identification is stored in the memory unit 132, retrieve at least part of the data associated with the item 150 identified by the item identification from the memory unit 132 and transmit the retrieved data to the user device 110, and possibly also transmit an instruction to the user interface 114 to indicate the transmitted data to the user by means of the user interface 114, responsive to the user device 110 having transmitted the item information to the store identification entity 130 via the communication network 140. When the user device 110 transmits the item information to the store identification entity 130 via the communication network 140, the store identification entity 130 becomes aware of that the item information has been obtained by the item information acquirer 112, for example that the item information has been obtained by the optical sensor 112 of the user device 110, e.g. that a barcode on the item 150 has been scanned or that an image of the item 150 has been captured. The instruction may be transmitted to the user device 110 together with the retrieved data.

Alternatively or in addition, the store identification entity 130 may be arranged to, on a condition that data associated with the item 150 identified by the item identification is stored in the memory unit 132, retrieve at least part of the data associated with the item 150 identified by the item identification from the memory unit 132, transmit the retrieved data to the user device 110, and possibly also transmit an instruction to the user interface 114 to indicate the transmitted data to the user by means of the user interface 114, on a condition that the item 150 identified by the identification has been, or is to be, purchased from the at least one store 120 that is offering the item 150 for sale.

For example, the store identification entity 130 may be arranged to, on a condition that data associated with the item 150 identified by the item identification is stored in the memory unit 132, retrieve at least part of the data associated with the item 150 identified by the item identification from the memory unit 132, transmit the retrieved data to the user device 110, and possibly also transmit an instruction to the user interface 114 to indicate the transmitted data to the user by means of the user interface 114, further on a condition that the store identification entity 130 has received a message indicating that the item 150 associated with the item identification was sold by at least one of stores 120.

The message indicating that the item 150 associated with the item identification was sold by at least one of stores 120 may for example be transmitted to the store identification entity 130 via the communication network 140 from the venue 160, which may be included in the communication network 140 (this case is not shown in FIG. 1), or from the at least one store 120 that sold the item 150 associated with the item identification.

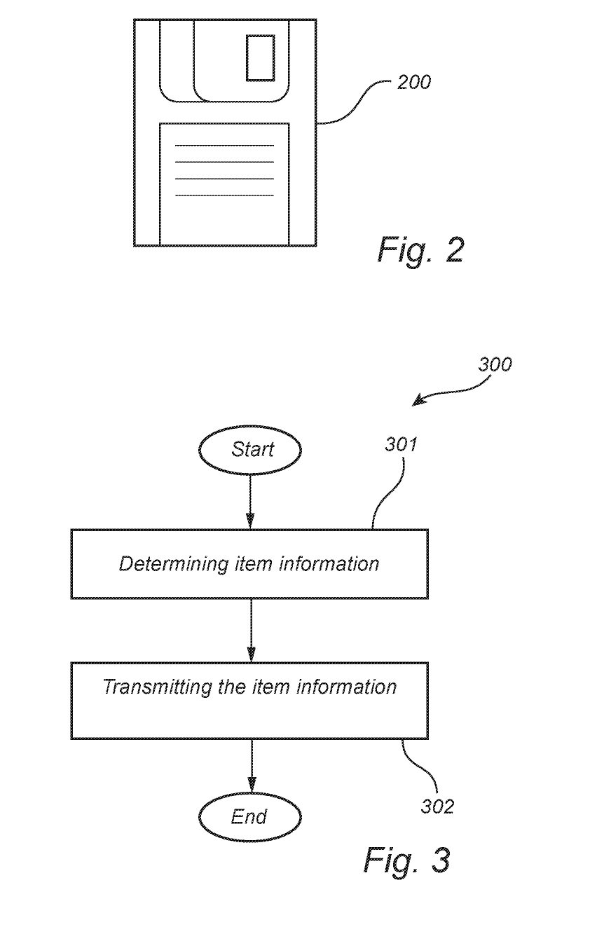

As indicated in FIG. 1, the user device 110 may include a processing unit 116. The store identification entity 130 may include a processing unit 136. The processing units 116, 136 will be further described in the following with reference to FIG. 2.

Referring now to FIG. 2, there is shown a schematic view of a computer-readable means, or computer-readable storage medium, 200 according to an embodiment of the present invention. The computer-readable storage medium 200 comprises a floppy disk. With reference to FIG. 1, the user device 110 and/or the store identification entity 130 may include a processing unit 116 and 136, respectively. On the computer-readable storage medium 200 there is stored a computer program code which is configured to, when executed in the processing unit 116, 136 of the user device 110 and/or store identification entity 130 according to embodiments of the present invention, perform a method or methods according to embodiments of the present invention.

According to an embodiment of the present invention, the computer-readable means carries computer program code configured to, when executed in the processing unit 116 of the user device 110, perform a method for facilitating determination by the store identification entity 130 whether at least one store 120 of the plurality of stores 120 is offering for sale a selected item 150 that is also for sale in a selected venue 160. The computer program code is configured to, when executed in the processing unit 116 of the user device 110, cause the item information acquirer 112 to acquire or determine item information relating to the item 150, wherein the item information includes an item identification identifying the item 150 and a venue identification identifying the venue 160. As described in the foregoing, the item information acquirer 112 may for example include an optical sensor 112, wherein the computer program code is configured to, when executed in the processing unit 116 of the user device 110, cause the optical sensor 112 to receive optical radiation reflected by at least a portion of the selected item 150 in the selected venue 160 and determine item information relating to the item 150 based on the received optical radiation, wherein the item information includes an item identification identifying the item 150 and a venue identification identifying the venue 160. The computer program code is configured to, when executed in the processing unit 116 of the user device 110, cause the user device 110 to transmit the item information to the store identification entity 130 via the communication network 140. Thereby, the store identification entity 130 is enabled to, based on the item identification included in the item information, receive information from at least part of the plurality of stores 120 via the communication network 140 regarding whether the respective stores 120 are offering the item for sale, and, on a condition that at least one store 120 is offering the item for sale, transmit an indication to the at least one store 120 via the communication network 140, wherein the indication includes the item identification and the venue identification.

According to another embodiment of the present invention, computer-readable means carries computer program code configured to, when executed in the processing unit 136 of the store identification entity 130, perform a method for determining whether at least one store 120 of the plurality of stores 120 is offering for sale a selected item 150 that is also for sale in a selected venue 160. The computer program code is configured to, when executed in the processing unit 136 of the store identification entity 130, cause the store identification entity 130 to receive the item information related to the selected item 150 from the user device 110 via the communication network 140. The computer program code is configured to, when executed in the processing unit 136 of the store identification entity 130, based on the item identification included in the item information, cause the store identification entity 130 to receive information from at least part of the plurality of stores 120 via the communication network 140 regarding whether the respective stores 120 are offering the item 150 for sale. The computer program code is configured to, when executed in the processing unit 136 of the store identification entity 130, on a condition that at least one store 120 is offering the item 150 for sale, cause the store identification entity 130 to transmit an indication to the at least one store 120 via the communication network 140, wherein the indication includes the item identification and the venue identification.

Although only one type of computer-readable storage medium 200 has been described above with reference to FIG. 2, the present invention encompasses embodiments employing any other suitable type of computer-readable storage medium, such as, but not limited to, a memory, a hard disk drive, a Compact Disc (CD), a Digital Versatile Disc (DVD), a flash memory, magnetic tape, a USB stick, a Zip drive, etc. The memory may for example be any combination of read and write memory (RAM) and read only memory (ROM).

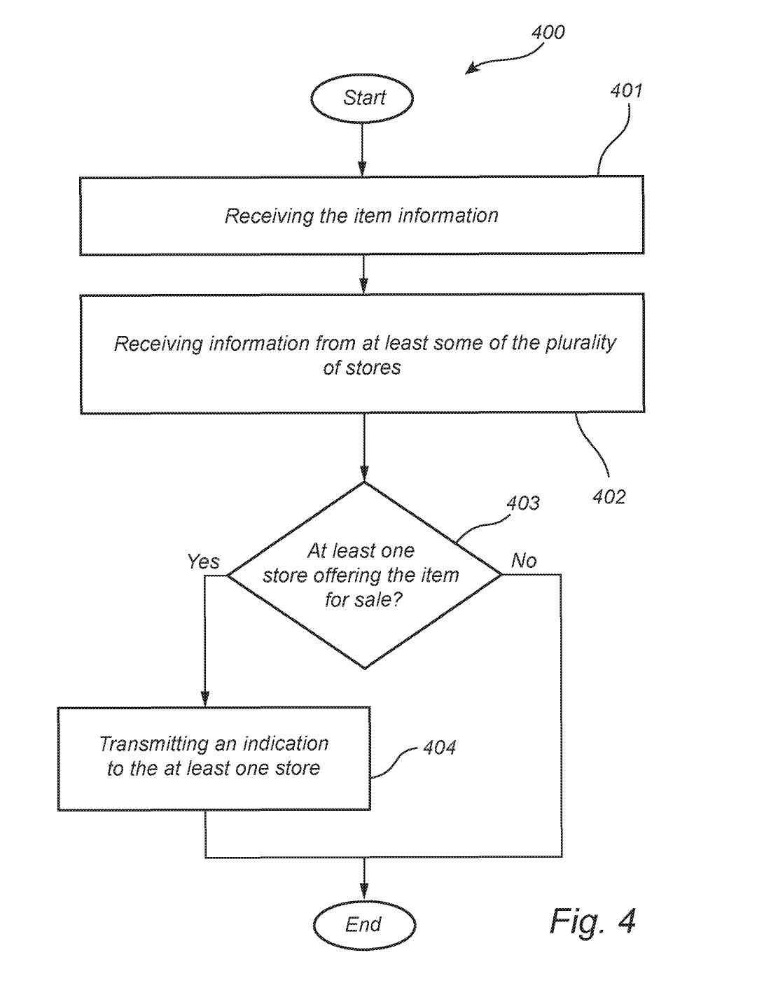

Referring now to FIG. 3, there is shown a schematic flowchart of a method 300 according to an embodiment of the present invention. The method 300 is for use in a user device included in a system, which in addition includes a plurality of stores and a store identification entity, wherein the user device, the store identification entity and the plurality of stores are included a communication network. The method 300 is for facilitating determination by the store identification entity whether at least one store of the plurality of stores is offering for sale a selected item that is also for sale in a selected venue. The user device includes an item information acquirer arranged to acquire item information related to an item. According to the embodiment illustrated in FIG. 3, the item information acquirer includes an optical sensor arranged to receive optical radiation reflected by at least a portion of an item and extract item information relating to the item based on the received optical radiation.

The method 300 comprises the item information acquirer determining or acquiring item information related to the selected item, wherein the item information includes an item identification identifying the item and a venue identification identifying the venue. According to the embodiment illustrated in FIG. 3, the method 300 comprises the optical sensor receiving optical radiation reflected by at least a portion of the selected item in the selected venue and determining item information relating to the item based on the received optical radiation, wherein the item information includes an item identification identifying the item and a venue identification identifying the venue, 301.

The item information is transmitted to the store identification entity via the communication network, 302.

Thereby, the store identification entity thereby is enabled to, based on the item identification included in the item information, receive information from at least part of the plurality of stores via the communication network regarding whether the respective stores are offering the item for sale, and, on a condition that at least one store is offering the item for sale, transmit an indication to the at least one store via the communication network, wherein the indication includes the item identification and the venue identification.

Referring now to FIG. 4, there is shown a schematic flowchart of a method 400 according to an embodiment of the present invention. The method 400 is for use in a store identification entity included in a system which in addition includes a user device and a plurality of stores, wherein the user device, the store identification entity and the plurality of stores are included in a communication network. The method 400 is for determining whether at least one store of the plurality of stores is offering for sale a selected item that is also for sale in a selected venue. The user device includes an item information acquirer arranged to acquire item information related to the item, wherein the item information includes an item identification identifying the item and a venue identification identifying the venue. According to the embodiment illustrated in FIG. 4, the item information acquirer includes an optical sensor arranged to receive optical radiation reflected by at least a portion of the item in the selected venue and determine item information relating to the selected item based on the received optical radiation, wherein the item information includes an item identification identifying the item and a venue identification identifying the venue.

The method 400 comprises receiving the item information related to the selected item from the user device via the communication network, 401. The item information includes the item identification identifying the item and the venue identification identifying the venue.

Based on the item identification included in the item information, information is received from at least part of the plurality of stores via the communication network regarding whether the respective stores are offering the item for sale, 402.

There is checked whether at least one store is offering the item for sale, 403.

On a condition that at least one store is offering the item for sale, an indication is transmitted to the at least one store via the communication network, 404, wherein the indication includes the item identification and the venue identification.

On a condition that no store is offering the item for sale, the method 400 ends.

With reference to any one of the methods 300 and 400 illustrated in FIGS. 3 and 4, it is to be understood that the optical sensor is merely an example of an item information acquirer. For example, the item information acquirer may in alternative or in addition to the optical sensor capture RFID data (e.g. based on reading an RFID tag) for acquiring or determining item information relating to the item utilizing RFID technology such as known to a person skilled in the art. According to another example, the item information acquirer may in alternative or in addition include a user interface arranged to receive user input that determines the item information, e.g. by allowing a user of the user device to enter or type in for example a name of the item, a model number of the item, an UPC of the item and/or the venue identification.

In conclusion, there is disclosed a system including a user device, a plurality of stores and a store identification entity, which are included in a communication network. The store identification entity is arranged to determine whether at least one store of the plurality of stores is offering for sale a selected item that is also for sale in a selected venue. The user device is arranged to determine item information relating to the item and transmit the item information to the store identification entity. The item information includes an item identification identifying the item, and possibly a venue identification identifying the venue. The store identification entity is arranged to, based on the item identification included in the item information, receive information from at least part of the plurality of stores regarding whether the respective stores are offering the item for sale. The store identification entity is arranged to, on a condition that at least one store is offering the item for sale, transmit an indication to the at least one store, wherein the indication includes the item identification and the venue identification. Hence, according to embodiments of the present invention the store identification entity transmits both the item identification and the venue identification to at least one store which sells the item, which venue identification identifies the venue in which the item is located. Transmitting both the item identification and the venue identification to the at least one store which sells the item identified by the item identification may for example facilitate or enable the venue to claim part benefit from any transaction occurring between a store and the user device, even if the user device or customer, e.g. the user of the user device, does not subsequently purchase the item from the venue. A user device and a store identification entity included in the system are also disclosed.

While the present invention has been illustrated and described in detail in the appended drawings and the foregoing description, such illustration and description are to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. The mere fact that certain measures are recited in mutually different dependent claims does not indicate that a combination of these measures cannot be used to advantage. Any reference signs in the claims should not be construed as limiting the scope.

1. A system including:
a user device, connected to a communication network, comprising an item information acquirer arranged to acquire item information relating to a selected item that is put on display by a venue, wherein the item information includes an item identification identifying the item and a venue identification identifying the venue;
a store identification entity, connected to the communication network, arranged to:
receive the item information from the user device;
determine whether at least one store is offering for sale the selected item that is put on display by the venue; and
on a condition that at least one store is offering the selected item for sale, transmit an indication to the at least one store via the communication network, wherein the indication includes the item identification and the venue identification.

2. A system according to claim 1, wherein the item information acquirer includes an optical sensor arranged to:
receive optical radiation reflected by at least a portion of the selected item that is put on display by the venue; and
determine at least part of the item information relating to the selected item based on the received optical radiation.

3. A system according to claim 1, wherein the item information acquirer includes an RFID communication device arranged to:
read data from an RFID tag of the selected item that is put on display by the venue; and
determine at least part of the item information relating to the selected item based on the data read from the RFID tag.

4. A system according to claim 1, wherein the at least one store is arranged to, on a condition that the item is purchased from the at least one store, transmit a message to the venue identified by the venue identification indicating that the item associated with the item identification was sold by the at least one store.

5. A system according to claim 1, wherein the at least one store is arranged to, on a condition that the item is purchased from the at least one store, transmit a message to the store identification entity indicating that the item associated with the item identification was sold by the at least one store.

6. A system according to claim 4, wherein the message includes an indication of a financial value to which the venue identified by the venue identification is entitled to.

7. A system according to claim 5, wherein the message includes an indication of a financial value to which the store identification entity is entitled to.

8. A system according to claim 1, wherein the store identification entity includes a memory unit arranged for storing data associated with the item that is put on display by the venue identified by the venue identification; and wherein the store identification entity is further arranged to:
on a condition that data associated with the item identified by the item identification is stored in the memory unit, retrieve at least part of the data associated with the item identified by the item identification from the memory unit; and
transmit the at least part of the data associated with the item identified by the item identification to the user device; said user device further including a user interface arranged to indicate the at least part of the data associated with the item identified by the item identification to a user of the user device.

9. A system according to claim 8, wherein the user device is further arranged for querying user input when the user interface indicates the at least part of the data associated with the item identified by the item identification to a user of the user device; and wherein a message based on the user input is transmitted from the user device to the store identification entity.

10. A user device arranged to be included in a system according to claim 9.

11. A store identification entity arranged to be included in a system according to claim 9.

12. A method in a user device comprising an item information acquirer, the user device connected to a store identification entity via a communication network, the method comprising:
the item information acquirer acquiring item information relating to a selected item that is put on display by a venue, wherein the item information includes an item identification identifying the item and a venue identification identifying the venue; and
the user device transmitting the item information to the store identification entity;
store identification entity, based on the item identification included in the item information, determining whether a least one store is offering the item for sale, and, on a condition that at least one store is offering the item for sale, transmitting an indication to the at least one store via the communication network, wherein the indication includes the item identification and the venue identification.

13. A method in a store identification entity connected to a user device via a communication network, the user device operating in accordance with the method of claim 12, the method comprising:
the store identification entity receiving the item information related to a selected item from the user device;
based on the item identification included in the item information, receiving information from at least one store regarding whether the at least one store is offering the item for sale; and
on a condition that at least one store is offering the item for sale, transmitting an indication to the at least one store via the communication network, wherein the indication includes the item identification and the venue identification.

14. A computer program product arranged to be executed in a processing unit of a user device included in a system further including a store identification entity, wherein the user device and the store identification entity are connected to a communication network, the computer program product comprising computer-readable means carrying computer program code configured to, when executed in the processing unit, perform a method according to claim 12.

15. A computer program product arranged to be executed in a processing unit of a store identification entity included in a system further including a user device, wherein the user device and the store identification entity are connected to a communication network, the computer program product comprising computer-readable means carrying computer program code configured to, when executed in the processing unit, perform a method according to claim 13.
